(19) United States
(12) Patent Application Publication
(10) Pub. No.: US 2002/0057317 A1
(43) Pub. Date: May 16, 2002

(54) INK CONTAINER CONFIGURED FOR USE WITH PRINTER

(76) Inventors: BRUCE COWGER, CORVALLIS, OR (US); JOHN A. BARINAGA, VANCOUVER, WA (US); JAMES E. CLARK, ALBANY, OR (US); JOHN A. UNDERWOOD, VANCOUVER, OR (US); PAUL DAVID GAST, BARCELONA (ES)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 08/789,959

(22) Filed: Jan. 30, 1997

Related U.S. Application Data
(63) Continuation-in-part of application No. 08/566,521, filed on Dec. 4, 1995, now abandoned.

(51) Int. Cl. B41J 2/175

(52) U.S. Cl. 347/86

(57) ABSTRACT

The present invention is a replaceable ink container for use in an ink-jet printer of the type having a scanning carriage having a plurality of ink-jet printheads mounted therein. The scanning carriage is capable of movement along a scan axis in a print zone portion and in a non-print zone portion. The selective activation of the plurality of ink-jet printheads in the print zone forms images on print media. The replaceable ink container includes an ink reservoir in fluid communication with at least one of the plurality of ink jet printheads. The reservoir includes a fluid outlet that is configured for engaging a corresponding fluid inlet associated with the ink-jet printer. Also included is a housing associated with the ink reservoir and the fluid outlet. With the ink container properly inserted into the ink-jet printer the housing has a width, parallel to the scan axis, that is sized to be less than a non-print zone width minus a sum of widths associated with remaining ink containers.

### CROSS-REFERENCE TO RELATED APPLICATIONS

This application is a continuation-in-part of U.S. patent application Ser. No. 08/566,521 filed Dec. 4, 1995, entitled “Keying System For Ink Supply Containers” incorporated herein by reference, and is related to commonly assigned applications filed herewith entitled, and Patent Application entitled “Electrical And Fluidic Interface For An Ink Supply”, Ser. No. ______, Attorney Docket number 10961158, filed Jan. 30, 1997, and Patent Application entitled “Ink Container Configured For Use With Compact Supply Station”, Ser. No. ______, Attorney Docket number 10961159, filed Jan. 30, 1997, “Electrical Interconnect For Replaceable Ink Containers”, Ser. No. ______, Attorney Docket number 10961160, filed Jan. 30, 1997 the entire contents of which are incorporated by reference herein.

### BACKGROUND OF THE INVENTION

The present invention relates to replaceable ink containers for providing ink to an ink-jet printhead. More specifically, the present invention relates to ink containers that are configured for use with printers to allow a printer layout having efficient use of space, accessible ink containers, and a reduced printer footprint.

Ink-jet printers frequently make use of an ink-jet printhead mounted to a carriage which is moved back and fourth across a print media, such as paper. As the printhead is moved across the print media, a control system activates the printhead to eject or jet ink droplets onto the print media to form images and text.

Previously used printers have made use of an ink container that is separably replaceable from the printhead. When the ink cartridge is exhausted the ink cartridge is removed and replaced with a new ink container. The use of replaceable ink containers that are separate from the printhead allow users to replace the ink container without replacing the printhead. The printhead is then replaced at or near the end of printhead life and not when the ink container is exhausted.

There is an ever present need for printing system that are small, reliable, and configured with ergonomics of the user in mind. Routine servicing such as replacing ink containers should be easily accomplished by the vast majority of printer users. In the case of color printing often four or more inks are used. For example, CYMK color printing makes use of cyan, yellow, magenta and black inks. Printers which make use of replaceable ink containers for each ink color must position these containers where they are readily accessible and readily graspable by the user for ease of replacement. Furthermore, these printers should be relatively small in both printer height and printer area to help minimize use of counter or desk space as well as maximize the flexibility of printer placement for the user.

### SUMMARY OF THE INVENTION

The present invention is a replaceable ink container for use in an ink-jet printer of the type having a scanning carriage having a plurality of ink-jet printheads mounted therein. The scanning carriage is capable of movement along a scan axis in a print zone portion and in a non-print zone portion. The selective activation of the plurality of ink-jet printheads in the print zone forms images on print media. The replaceable ink container includes an ink reservoir in fluid communication with at least one of the plurality of ink jet printheads. The reservoir includes a fluid outlet that is configured for engaging a corresponding fluid inlet associated with the ink-jet printer. Also included is a housing associated with the ink reservoir and the fluid outlet. With the ink container properly inserted into the ink-jet printer the housing has a width, parallel to the scan axis, that is sized to be less than a non-print zone width minus a sum of widths associated with remaining ink containers.

### BRIEF DESCRIPTION OF THE DRAWINGS

FIG. 1 shows a schematic representation of the printing system showing a ink container of the present invention which forms a fluid interconnect and an electrical interconnect with the printing system.

FIG. 2 is a perspective view of a printer with cover removed, which incorporates the ink container of the present invention.

FIG. 3 is an ink supply receiving station of the type used in the printer of FIG. 2, shown broken away, with an ink supply positioned for insertion into the ink supply receiving station.

FIG. 4 is a schematic representation of a top plan view of the printer shown in FIG. 2.

FIGS. 5a, 5b, 5c depicts an isometric view of one preferred embodiment of the ink container of the present invention.

FIGS. 6a, 6b, 6c depicts an isometric view of an alternate embodiment of the ink container of the present invention.

### DETAILED DESCRIPTION OF THE PREFERRED EMBODIMENT

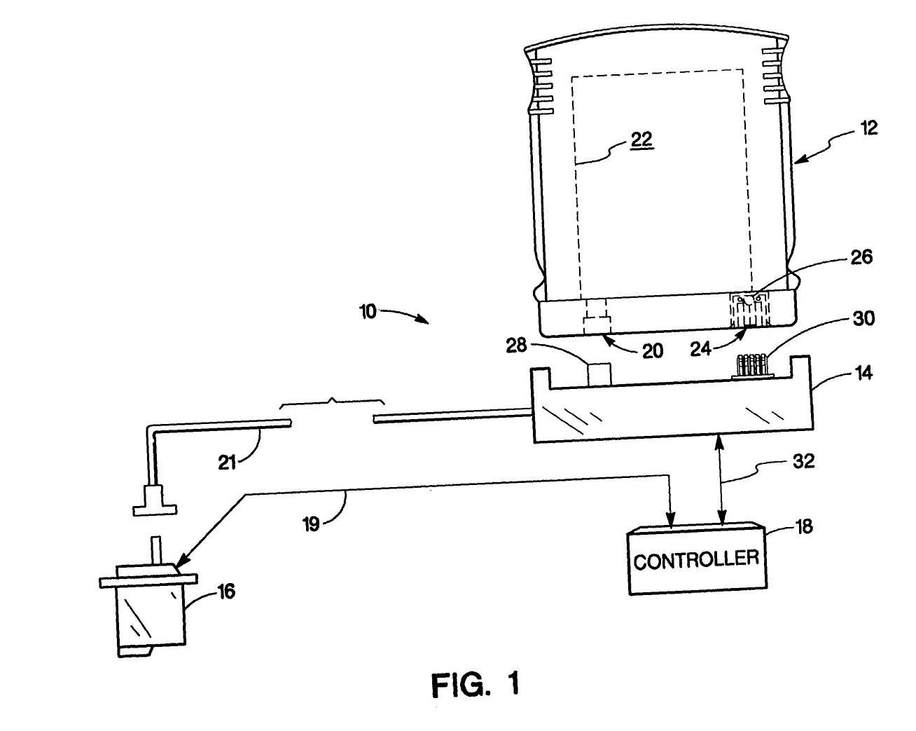

FIG. 1 is a schematic representation which depicts an ink-jet printer 10 that includes an ink container 12 of the present invention. The ink-jet printer 10 also includes an ink container receiving station 14, an ink-jet printhead 16 and a print controller 18. Printing is accomplished by the printer 10 by the ejection of ink from the printhead 16 under the control of print controller 18. The printhead 16 is connected to the controller 18 by a link 19 for controlling ejection of ink. Ink is provided to the printhead 16 by way of a fluid conduit 21 which fluidically connects the printhead 16 to the receiving station 14. The ink container 12 includes a ink outlet 20 which is in fluid communication with a fluid reservoir 22. In one preferred embodiment the ink container 12 includes a electrical contacts 24 which are electrically connected to an information storage device 26.

The ink outlet 20 and the electrical contacts 24 allow the ink container 12 to reliably interconnect with a fluid inlet 28 and a electrical contacts 30, respectively, associated with the ink cartridge receiving station 14. The ink cartridge receiving station 14 enables ink to be transferred from the fluid reservoir 22 associated with the ink container 12 to the printhead 16 via the fluid conduit 21. In addition, the ink container receiving station 14 allows the transfer of information between the information storage device 26 associated with the ink container 12 and the print controller 18 via a link 32.

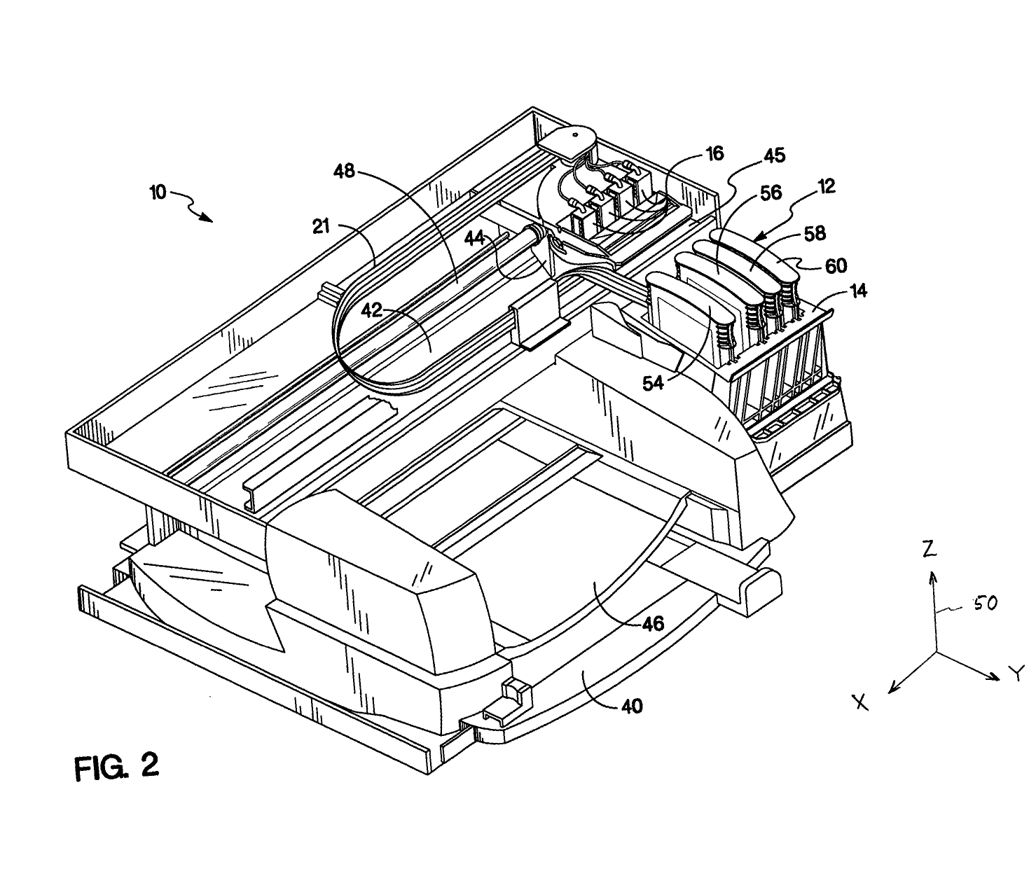

FIG. 2 depicts a perspective view of one embodiment of the ink-jet printer 10, with its cover removed, containing one or more ink containers 12 which incorporates the plurality of electrical contacts 24 and the ink outlet 20 of the present invention, shown in FIG. 1.

The printer 10 includes a tray 40 for holding a paper supply. When a printing operation is initiated a sheet of paper from tray 40 is fed into printer 10 using a sheet feeder (not shown). During printing the paper passes through a print zone 42 whereupon a scanning carriage 44, containing one or more printheads 16, is scanned across the sheet for printing a swath of ink thereon.. The sheet of paper is stepped through the print zone 42 as the scanning carriage 44 prints a series of swaths of ink to form images thereon.

After printing is complete, the sheet is positioned into an output tray 46, the positioning of the paper supply 40 and the output tray 46 can vary depending on the particular sheet feed mechanism used.

The scanning carriage 44 moves through the print zone 42 on a scanning mechanism which includes a slide rod 48 on which the scanning carriage 44 slides. A coordinate system 50 is depicted as having 3 mutually orthogonal axis, (x, y, z) with the x axis being parallel to the direction of movement by the scanning carriage 44 and the y axis in the direction the print media is stepped through the print zone 42. A positioning means such as a coded strip (not shown) is used in conjunction with a photo detector in the scanning carriage 44 for precisely positioning the scanning carriage 44. A stepper motor (not shown), connected to the scanning carriage 44 using a conventional drive belt and pulley arrangement, is used for transporting the scanning carriage 44 across the print zone 42.

A ribbon cable (not shown) carries electrical signals to the scanning carriage 44 for selectively energizing the printheads 16. As the printheads 16 are selectively energized, ink of a selected color is ejected onto the print media as the scanning carriage 44 passes through the print zone 42.

The scanning carriage 44 in FIG. 2 is shown positioned at an non-printing portion or in a service station 45 disposed adjacent the print zone portion 42. The service station 45 maintains the printheads 16 to ensure optimum print quality over time. The service station 45 typically performs one or more of the following operations: a) printhead priming, b) covering an orifice plate and other openings in the printhead when the printhead is not in use, c) wiping contaminants from the orifice plate, d) preventing ink from drying in openings within the orifice plate, e) providing a location to eject soft, viscous plugs of ink from drying out in the openings of the orifice plate. Service stations for ink-jet printers 10 are discussed in more detail in U.S. Pat. No. 5,300,958 to Burke et al. Entitled “Method and Apparatus for Automatically Cleaning the Printhead of a Thermal Inkjet Cartridge”, assigned to the assignee of the present invention and incorporated herein by reference.

The present invention relates to the ink container 12 which provides ink to the printheads 16 for ejection onto print media. The ink container 12 is referred to as an off-axis ink supply because the ink supply is spaced from a scan axis along the x axis which is defined by the scanning carriage 44. This off-axis ink delivery system includes an ink receiving station 14, for receiving ink container 12. These ink container 12, in the case of color printing, are often separate ink containers for each color and a container for black ink. For example the ink container 12 for one preferred embodiment shown in FIG. 2 is an ink container 54 for black ink, an ink container 56 for yellow ink, an ink container 58 for magenta ink, and an ink container 60 for cyan ink. The receiving station 14 contains a mechanical interface, a fluid interface, and an electrical interface. The ink container 12 is inserted into the receiving station 14 generally along a z axis in the coordinate system 50 which is a direction generally orthogonal to both the scan axis (x axis) and the direction along the y axis which media is stepped during advancement through the print zone. Once the ink container 12 is properly inserted and latched into place these electrical, mechanical and fluidic interfaces are accomplished with the printer 10. Ink passes through these fluid interfaces in the receiving station 14 through a fluid conduit 21 such as tubing which fluidly connect the ink containers,54, 56, 58, and 60 with corresponding printheads 16 on the print scanning carriage 44.

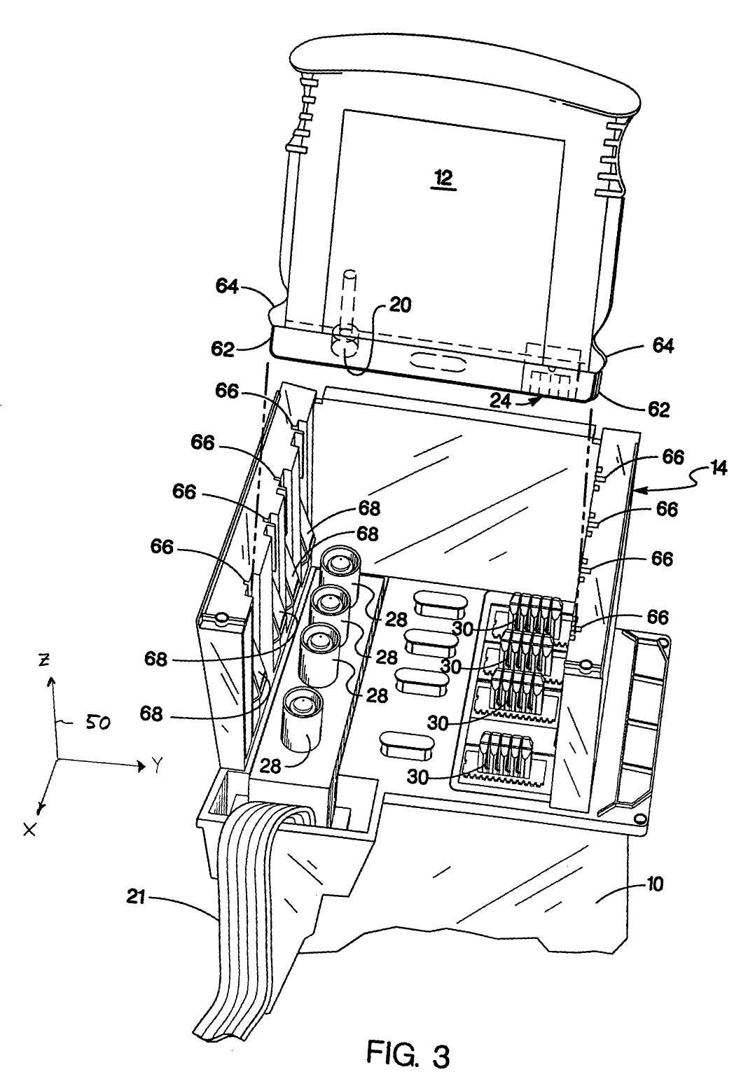

FIG. 3 depicts an ink container 12 of the present invention positioned for insertion into the receiving station 14 of printer 10. The ink container 12 contains a supply of media marking fluid such as ink. Also included in the ink container 12 is the ink outlet 20, the plurality of electrical contacts 24, aligning features 62 and latching features 64. The aligning features 62 on the ink container 12 are to assist in aligning the ink container 12 for insertion into the receiving station 14. The aligning features 62 work in conjunction with corresponding aligning features 66 on the receiving station 14. These aligning features 62 and 66 in addition to providing an aligning function, also provide a keying function to ensure that the ink container 12 contains ink having the proper parameters such as proper color and is compatible with the particular printer 10. Keying and aligning features are discussed in more detail in co-pending patent application Ser. No. 08/566,521 filed Dec. 4, 1995 entitled “Keying System For Ink Supply Containers” assigned to the assignee of the present invention, incorporated herein by reference.

Once the proper ink container 12 is properly aligned and inserted into the receiving station 14, a latching feature 68 engages the corresponding latching feature 64 on the ink container 12 to latch the container into the receiving station 14. With the ink container 12 properly latched into the receiving station 14 a fluid inlet 28 associated with the receiving station 14 engages the corresponding ink outlet 20 on the ink container 12 to allow fluid to flow from the ink container 12 to the printer 10 and ultimately the printhead 16 for printing on print media.

Insertion of the ink container 12 into the receiving station 14 forms an electrical interconnect between the ink container 12 and the receiving station 14. Electrical contacts 24 associated with the ink container 12 engages corresponding electrical contacts 30 associated with the receiving station 14 to allow information to be transferred between the receiving station 14 and the ink container 12. It is the positioning of these electrical contacts 24 on the ink container 12 that allow a highly reliable electrical contact to be formed between the receiving station 14 and the ink container 12.

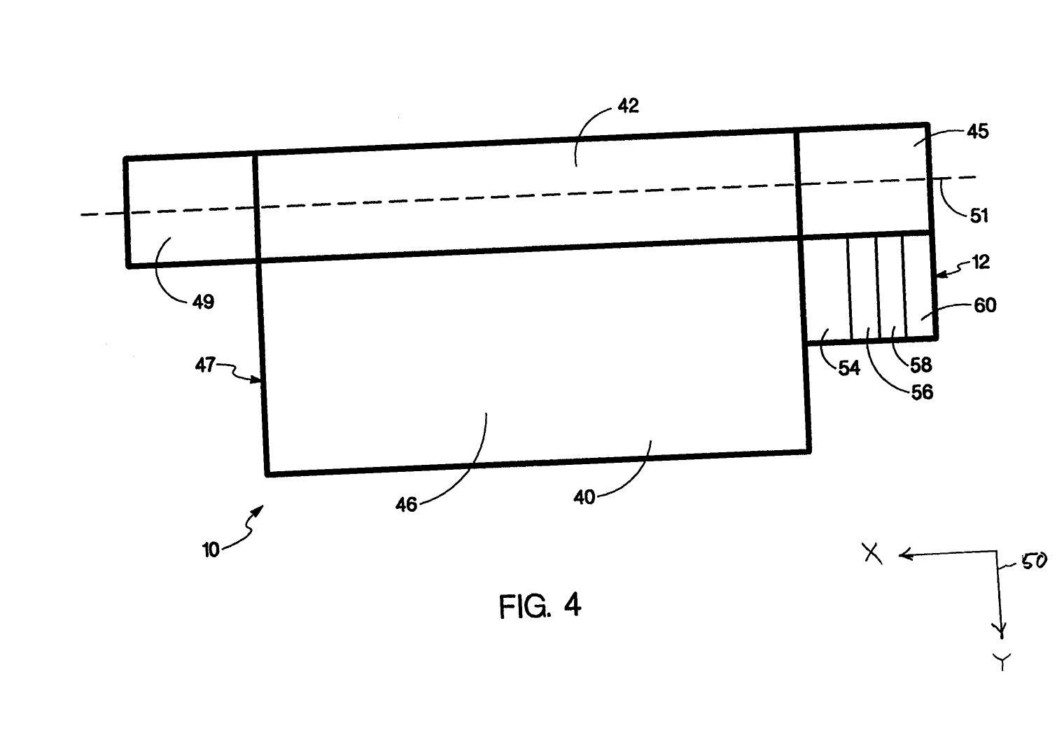

FIG. 4 depicts a schematic representation of a top plan view of the printer 10 shown in FIG. 2. This representation is intended only to show general printer layout features and is not intended to be an accurate or proportional representation on the printer 10 layout. The printer 10 includes a media transport portion 47, the print zone portion 42, the service station 45, ink containers 12 and an overtravel portion 49. The media transport portion 47 includes the paper tray 40 and the output tray 46 which are positioned forward from the print zone 42. Adjacent the print zone 42, along the scan axis 51 as represented by the x axis in coordinate system 50, is the service station 45. The service station in one preferred embodiment is disposed to the right of the print zone from the perspective of one facing the front of the printer 10. Adjacent the print zone 42, opposite the service station 45 and along the scan axis 51 is the overtravel portion 49.

The overtravel portion 49 results from the overtravel of the carriage 44 to either side of the printzone 42 as printheads 16 are each position at either edge of the print media. Each of the plurality of printheads 16 are arranged along the scan axis 51 within the carriage 44. Therefore, to position individual nozzles associated with each of the plurality of printheads at either edge of the print media the print carriage must overtravel or extend beyond the print media on either side of the printzone 42. The width of this overtravel portion 49 at the left side of the printer 10 is approximately equal to the distance the furthest right printhead nozzle is spaced from the left edge of the carriage 44.

In the embodiment depicted in FIG. 4 the ink containers 12 are arranged forward of the service station 45. In this preferred embodiment each of the ink containers 54, 56, 58, and 60 are arranged in a side by side arrangement along a line parallel to the scan axis 51.

Each of the ink containers 54, 56, 58 and 60 are configured to have a width in the direction of the scan axis 51 or x axis and a length in the direction orthogonal to the width and a height orthogonal to both the length and the width. The ink containers 54, 56, 58 and 60 can all have identical widths as shown in FIG. 2 or one or more of these ink containers 54, 56, 58 and 60 can have larger or smaller widths depending on the volume of the ink container desired. For example, in the case of the four color printer 10 shown in FIG. 2, if black ink which is provided to the printhead 16 by ink container 54 is consumed faster than the yellow, magenta ink, and cyan ink provided by ink containers 56, 58, and 60, respectively, then a larger ink container (not shown) can be substituted for the ink container 54. This larger ink container for black ink is provided as a convenience to the user to reduce a frequency of ink container replacement.

The ink containers 54, 56, 58 and 60 are in a spaced relationship that is generally parallel to the scan axis 51 to allow users to see each ink containers 12 as well as provide easy access to each container 12 for replacing the container 12. In addition, the service station 45 is positioned to the right side of the printzone 42 because the service station has a width, along the scan axis 51, that is typically larger than a width, along the scan axis 51, associated with the overtravel portion 49. The carriage 44 typically has overtravel to the night side of the print zone 42 for the same reason the carriage overtravel portion 49 to the left side of the print zone 42. However, the service station 45 tends to have a greater width in the scan axis 51 than the overtravel portion 49 because the carriage 44 is typically moved completely out of the print zone 42 for printhead servicing.

Placement of the service station to the right side of the print zone 42 provides a greater area for positioning the ink containers 12 which are placed on the right side for ease of access by right handed users. Positioning the ink containers on the right side establishes greater ease of access to the ink containers 12 by right handed users which are the predominant users. Furthermore, positioning the ink containers on the right side in conjunction with placing the service station 45 on the right side allows more room for positioning the ink containers 12 without adding to the printer overall width in a direction parallel to the scan axis 51.

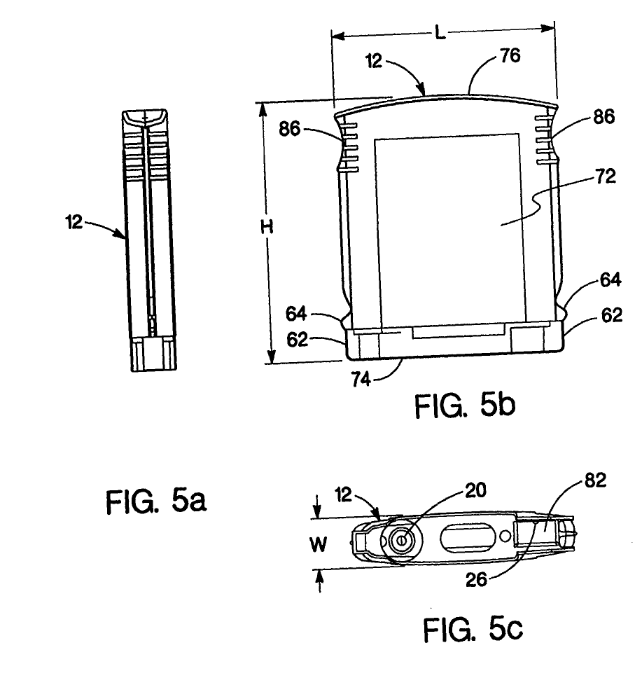

FIGS. 5a, 5b, and 5c depicts isometric views of one preferred ink container 12 of the present invention. The ink container 12 includes an outer surface or housing 72 having a leading edge 74 and a trailing edge 76 relative to the direction of insertion of the ink container 12 into the receiving station 14.

The outer surface 72 defines an opening 82 into a cavity at the leading edge 72 of the ink container 12 shown in FIG. 5c. A storage device 26 having a plurality of electrical contacts 24 (shown in FIG. 1) associated therewith are mounted within the cavity. The electrical contacts are configured to engage corresponding electrical contacts associated with the receiving station 14 when the ink container 12 is properly inserted into the printer 10.

Also disposed on the leading edge 74 is the fluid outlet 20. The fluid outlet 20 is configured to engage the corresponding fluid inlet 28 on the supply station 14 to form a fluid interconnect between the ink container 12 and the printer 10.

Aligning features 62 and latching features 64 are provided on the ink container 12. The aligning features 62 aid in the insertion of the ink container 12 into the receiving station 14. Once the ink container 12 is inserted into the receiving station 14, the latching features 64 engage the spring 68 to secure the ink container 12 into the receiving station 14. (see FIG. 3) In addition, gripping features 86 are provided toward the trailing edge 76 of the ink container 12.

The ink container 12 has a height and length associated therewith designated by letters h and l, respectively, in FIG. 5b. The length, l, is in a direction generally orthogonal to the scan axis 51 and the height, h, is in a direction generally orthogonal to both the scan axis 51 and the length, l. The ink container 12 has a width associated designated by the letter w in FIG. 5c. The width, w, is in a direction generally parallel to the scan axis 51.

The width, w, of the ink container 12 is selected to be less than a width associated the service station 45 minus the widths, w, of the remaining ink containers 12. For example, if all of the ink containers 12 have the same width, w, then the width of each ink container 12 is less than the width associated with the service station 51 divided by the number of ink containers 12. Therefore, the ink containers 12 have a width, w, associated with each container to allow all of the ink containers 12 to be arranged side by side, in a width direction, such that a combined widths of each of the ink containers 12 is less than the width associated with the service station 45. The sizing of the widths of the ink containers 12 based on the width of the service station 45 for maintaining a relatively small overall width along the scan axis 51 for the printer 10. In the preferred embodiment depicted in FIGS. 5a, 5b, and 5c the width, w, of the ink container 12 is approximately 15 millimeters (mm).

The length, l, of the ink container 12 is selected based on human ergonomics or an ability of a user to grasp the ink container 12. In the preferred embodiment the length, l, of the ink container 12 is selected such that a majority of users can grasp the ink container 12 between thumb and forefinger across the length, l, of the ink container. In this preferred embodiment the length, l, is selected to conform to the grasping width or anthropometric limit, for grasping using thumb and forefinger for the 5 percentile female user. Therefore, 95 percent of the female users are capable of grasping the ink container 12 using thumb and forefinger to grasp the ink container 12 in the length direction. In this preferred embodiment the ink container 12 has a length that is approximately 70 millimeters.

The height, h, of the ink container 12 is selected based upon a tradeoff between convenience to the user and ensuring maximum print quality. The ink container 12 should be large to minimize the frequency of replacement and should be small enough such that the ink container 12 is exhausted before aging effects such as VTR loss reduce print quality. In one preferred embodiment the ink container 12 is selected to have a height of 85 millimeters which allows at least one ink container to have a volume of approximately 80 cubic centimeters (cc) of ink and 3 ink containers to have a volume of approximately 30 cubic centimeters (cc) of ink. A high volume user will typically consume 80 cc's of black ink and 30 cc's of each color ink in a range of 2 to 6 months. Sizing the ink container 12 such that ink is consumed prior to 6 months helps assure maximum print quality. Finally, the height, H, should be selected so that an overall height of the printer 10 is kept small thereby tending to minimize the printer 10 overall size.

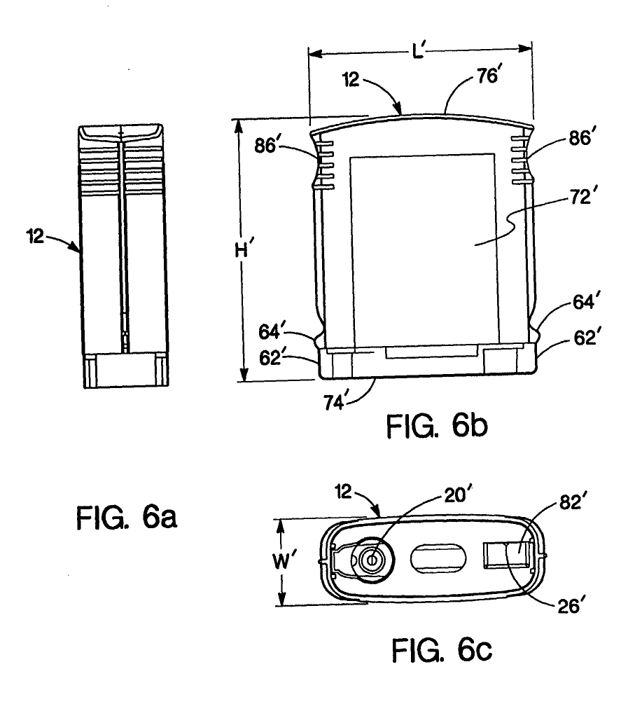

FIGS. 6a, 6b, and 6c depicts isometric views of another preferred embodiment of the ink container 12 of the present invention. The ink container 12 is similar to the ink container depicted in FIGS. 5a, 5b, and 5c except that the ink container in FIGS. 6a, 6b, and 6c has a greater width, W, allowing this container 12 to contain greater volumes of ink. Similar numbering and lettering in FIGS. 6a, 6b, and 6c is used to identify structures that are similar to structures depicted in FIGS. 5a, 5b, and 5c.

The ink container 12 has a height and length associated therewith designated by letters H′ and L′, respectively, in FIG. 5b. The length, L′, is in a direction generally orthogonal to the scan axis 51 and the height, H′, is in a direction generally orthogonal to both the scan axis 51 and the length, L′. The ink container 12 has a width associated designated by the letter W′ in FIG. 5c. The width, W′, is in a direction generally parallel to the scan axis 51.

In one preferred embodiment the ink container 12 is selected to have a height, H′, of 85 millimeters, a width, W′, which is approximately 32 millimeters (mm) and a length of approximately 73 millimeters. This preferred ink has a volume of approximately 80 cubic centimeters (cc). A cavity 82′ is defined in an outer surface 72′ similar to the ink cartridge 12 shown in FIGS 5a, 5b, and 5c. Both the cavity 82′ having electrical contacts 26′ and fluid outlet 20′ are positioned in an identical position relative to aligning features 62′ thereby allowing either the small 30 cc or the large 80 cc ink cartridge 12 to be inserted into the same slot. By allowing at least one slot in the service station 14 to receive ink cartridge 12 of varying width provides greater convenience for the user. For example, if the printer application uses one color at a faster rate than the other colors then the user can use a larger volume ink container 12 thereby reducing the frequency of replacement. Typically, black ink is used at a higher rate and therefore, the black ink container slot is spaced to accommodate varying width ink containers 12.

The present invention provides an ink container 12 that provides a reliable electrical and fluidic interconnect between the ink container 12 and the ink receiving station 14. The sizing of the ink containers 12 to fit within a space at least partially defined by the service station 45 tends to maintain a small overall width for the printer 10. In addition, the positioning of the ink containers 12 in an arrangement that is parallel to the scan axis 51 and positioned in front of the service station 45 and to the right of the paper trays 40 and 46 ensure easy access for changing the ink containers 12. Finally, the orientation of the ink containers 12 in a generally vertical orientation with the fluid and electrical interconnect on the leading edge provides an arrangement that is convenient and allows for ease of insertion and removal of the ink containers 12.

What is claimed is:

1. A replaceable ink container for use in an ink-jet printer of the type having a scanning carriage having a plurality of ink-jet printheads mounted therein, the scanning carriage being capable of movement along a scan axis in a print zone portion and in a non-print zone portion, selective activation of the plurality of ink-jet printheads in the print zone forms images on print media, the replaceable ink container comprising:
an ink reservoir in fluid communication with at least one of the plurality of ink jet printheads, the reservoir including a fluid outlet configured for engaging a corresponding fluid inlet associated with the ink-jet printer; and
a housing associated with the ink reservoir and the fluid outlet, with the ink container properly inserted into the ink-jet printer the housing having a width associated therewith, parallel to the scan axis, that is sized to be less than a non-print zone width minus a sum of widths associated with remaining ink containers.

2. The replaceable ink container of claim 1 wherein the housing width is sized to allow ink containers associated with each of the plurality of ink-jet printheads to have a combined width that is less than a width, parallel to the scan axis, associated with the non-print zone portion.

3. The replaceable ink container of claim 1 is a plurality of ink containers with each of the plurality associated with each of the plurality of ink-jet printheads, wherein a housing associated with each of the plurality of ink containers is sized to have a width, parallel to the scan axis, that the combined widths of each of the plurality of ink containers is less than a width, parallel to the scan axis, associated with the non-print zone portion.

4. The replaceable ink container of claim 3 wherein the width associated with each of the plurality of ink containers are not identical.

5. The replaceable ink container of claim 1 wherein the housing has a length associated therewith, in a direction orthogonal to both the scan axis and the width direction, that is based on human grasping capabilities.

6. The replaceable ink container of claim 5 wherein the housing has a length that is based on human grasping capabilities between thumb and forefinger.

7. The replaceable ink container of claim 5 wherein the housing has a length associated therewith, in a direction orthogonal to both the scan direction and the width direction that is less than 75 millimeters.

8. The replaceable ink container of claim 1 wherein the housing has a width, in a direction parallel to the scan axis, a depth, and a height with the height being larger than the width and with the depth larger than the width.

9. The replaceable ink container of claim 1 wherein the housing has a width, in a direction parallel to the scan axis, that is less than 40 millimeters, a length that is less than 75 millimeters.

10. The replaceable ink container of claim 9 wherein the housing has a width that is less than 20 millimeters.

11. The replaceable ink container of claim 1 wherein the non-print zone portion is a service station portion for maintaining printhead reliability.

12. A replaceable ink container for use in an ink-jet printer of the type having a scanning carriage having a plurality of ink-jet printheads mounted therein, the scanning carriage being capable of movement along a scan axis in a print zone portion and in a printhead service portion, selective activation of the plurality of ink-jet printheads in the print zone forms images on print media, the printhead service portion for providing service to the plurality of ink-jet printheads, the replaceable ink container comprising:
an ink reservoir in fluid communication with at least one of the plurality of ink jet printheads, the reservoir including a fluid outlet configured for engaging a corresponding fluid inlet associated with the ink-jet printer; and
a housing associated with the ink reservoir and the fluid outlet, with the ink container properly inserted into the ink-jet printer the housing having a width associated therewith, that is sized to be less than a service station width minus a sum of widths associated with remaining ink containers.

13. An ink-jet printing system for forming images on print media, the ink-jet printing system comprising:
a scanning carriage for movement along a scan axis in a print zone portion and in an overtravel portion adjacent the printzone portion;
a plurality of ink-jet printheads configured for insertion into the scanning carriage, selective activation of the plurality of ink-jet printheads in the print zone forms images on print media;
a plurality of replaceable ink containers configured for mounting in a supply station disposed adjacent the overtravel portion, the plurality of replaceable ink containers have a docked position with the supply station with each of the plurality of ink containers in fluid communication with a corresponding ink-jet printhead of the plurality of ink-jet printheads, the plurality of ink containers in the docked position are each positioned along a line parallel to the scan axis with each of the plurality of ink containers having a width parallel to the scan axis that is selected to be sufficiently small that a combined width of the plurality of ink containers is not greater than a width associated with the overtravel portion.
